(19) United States
(12) Patent Application Publication
(10) Pub. No.: US 2020/0080853 A1
(43) Pub. Date: Mar. 12, 2020

(54) SYSTEMS AND METHODS FOR RENDEZVOUSING

(71) Applicant: Peloton Technology, Inc., Mountain View, CA (US)

(72) Inventors: Joyce Tam, Pleasanton, CA (US); Joshua P. Switkes, Mountain View, CA (US)

(73) Assignee: Peloton Technology, Inc., Mountain View, CA (US)

(21) Appl. No.: 16/123,790

(22) Filed: Sep. 6, 2018

(51) Int. Cl. G01C 21/34; G05D 1/02; G08G 1/00

(52) U.S. Cl. CPC G01C 21/3438; G05D 1/0291; G05D 2201/0213; G05D 1/0212; G05D 1/0276; G08G 1/22

(57) ABSTRACT

Systems and methods for increasing the efficiency of vehicle platooning systems are described. In one aspect, data associated with two or more vehicles is received by a system. The data received by the system may indicate where two or more vehicles may rendezvous such that they can platoon. In some examples, a rendezvous location may be determined based on the time it would take the vehicles to arrive at the location and/or the amount of fuel that would be spent if the vehicles were to travel out of their way to arrive at the location. Example user interfaces are described that include maps indicating where a rendezvous location is, and which may include information about where other vehicle(s) are that are also traveling to the rendezvous location.

### BACKGROUND

Enabling a vehicle to follow closely behind one vehicle safely through partial or full automation has significant fuel savings, safety, and/or labor savings benefits, but is generally unsafe when a driver tries to do this manually. Presently, during normal driving, vehicle motion is controlled either manually, by a driver, or by convenience systems, such as cruise control or adaptive cruise control. The various types of cruise control systems control vehicle speed to make driving more pleasurable or relaxing, by partially automating the driving task. Some of these systems use range sensors and/or vehicle sensors to control the speed to maintain a constant headway relative to the leading vehicle (also referred to herein as a front vehicle). In general, these cruise control systems provide minimal added safety, and do not have full control of the vehicle (in terms of being able to fully brake or accelerate).

Driver control does not match the safety performance of even current systems, for several reasons. First, a driver cannot safely maintain a close following distance. In fact, the relatively short distances between vehicles necessary to get any measurable fuel savings results in an unsafe condition if the vehicle is under driver control, thereby risking a costly and destructive accident. Further, the driver is not as capable of maintaining a constant headway as an automated system is. In fact, a driver trying to maintain a constant headway often causes rapid and large changes in command (accelerator pedal position for example), resulting in a loss of efficiency.

Thus, it would be desirable to have reliable and economical semi-automated vehicular convoying or platooning systems which enable vehicles to follow closely together in a safe, efficient, convenient manner.

However, even if a system enables vehicles to follow together in a safe and convenient manner, it may still be difficult to create efficiencies when a variety of vehicles—which may or may not be capable of platooning—are located throughout various highways, and have trouble locating each other. Thus, in some platooning systems, the ability to allow vehicles capable of platooning to rendezvous with each other (e.g., meet at a particular time and place) is desirable, particularly since there are no systems currently available in the art to perform such tasks.

Moreover, broader applications are envisioned for such a system, which may not involve platooning, or vehicles at all.

### SUMMARY

The system and methods comprising various aspects of the disclosure described herein provide for more efficient rendezvousing of two vehicles. For example, without limitation, aspects of the present invention enable the determination of a location for a first platoonable vehicle and a second platoonable vehicle to rendezvous. Data including a location of a first platoonable vehicle may be received, and data including a location of a second platoonable vehicle may be received. A determination of a route that the first platoonable vehicle plans to travel may be made, and a determination of a route that the second platoonable vehicle plans to travel may be made. In addition, a location for the first platoonable vehicle and the second platoonable vehicle to rendezvous may be determined. The location may be based on a location of the first platoonable vehicle, the location of the second platoonable vehicle, the route the first platoonable vehicle plans to travel, and the route the second platoonable vehicle plans to travel.

As another example, aspects of the present invention enables the determination of a rendezvous location. A first location of a first platoonable vehicle may be received, and a second location of a second platoonable location may be received. A rendezvous location may be determined for the first platoonable vehicle and the second platoonable vehicle based on the first location of the first platoonable vehicle and the second location of the second platoonable vehicle.

As yet another example, a rendezvousing engine may be configured to receive a first location of a first platoonable vehicle, receive a second location of a second platoonable vehicle, and determine a rendezvous location for the first platoonable vehicle and the second platoonable vehicle.

As yet another example, a method for determining a rendezvous location is described. Locations of two electronic devices are received. Based on those locations, a rendezvous location for the two devices is selected, and shown to users of the devices.

It will be appreciated by those skilled in the art that the various features of the present disclosure can be practiced alone or in combination. These and other features of the present disclosure will be described in more detail below in the detailed description of the disclosure and in conjunction with the following figures.

### BRIEF DESCRIPTION OF THE DRAWINGS

In order to describe the various aspects of the present disclosure, some detailed description now will be provided, by way of illustration, with reference to the accompanying drawings, in which:

FIG. 1 illustrates a diagram of a platooning system, in accordance with some embodiments;

FIG. 2 illustrates a block diagram of a platooning system, in accordance with some embodiments;

FIG. 3 illustrates a block diagram of a system including an electronic control unit, in accordance with some embodiments;

FIGS. 4A-C illustrate example maps including vehicles on roads, in accordance with some embodiments;

FIGS. 5A-B illustrate example user interfaces, in accordance with some embodiments;

FIGS. 6A-6D illustrate example electronic devices including displays, in accordance with some embodiments;

FIG. 7 illustrates a flow chart of an example process, in accordance with some embodiments;

FIG. 8 illustrates an example computing system, in accordance with some embodiments.

### DETAILED DESCRIPTION

The present invention will now be described in detail with reference to several embodiments thereof as illustrated in the accompanying drawings. In the following description, numerous specific details are set forth in order to provide a thorough understanding of embodiments of the present invention, including the description of a plurality of different aspects of the invention, including, in some cases, one or more alternatives. It will be apparent to those skilled in the art that the invention can be practice without implementing all of the features disclosed herein.

Although many embodiments included in the instant application are related to the concept of platooning, it should be appreciated that many broader applications are envisioned. In particular, various embodiments described herein discuss a system (e.g., a navigation system) where two or more entities (e.g., vehicles) are attempting to rendezvous. In various embodiments described herein, a location for the rendezvous may be determined, and in some cases that location may change prior to the rendezvous occurring. For example, two vehicles may attempt to meet somewhere between their current locations, and a system may indicate that a rendezvous location should be halfway between their current locations. However, when one vehicle stops at a gas station, the system may update the rendezvous location such that it is closer to the starting point of the vehicle that stopped at the gas station, and farther from the starting point of the vehicle that did not stop at a gas station. This way, the vehicles will rendezvous sooner than if the vehicle that did not stop at the gas station were forced to wait at the halfway location while the vehicle that stopped for gas is delayed.

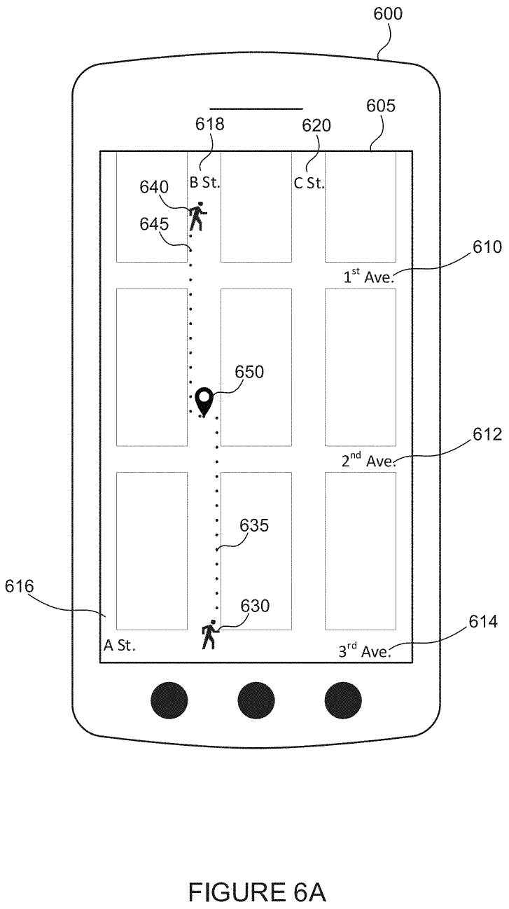

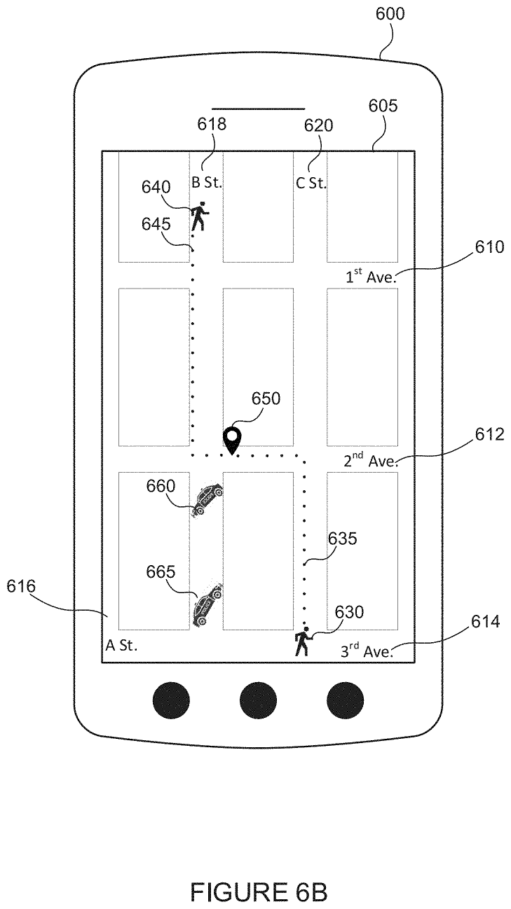

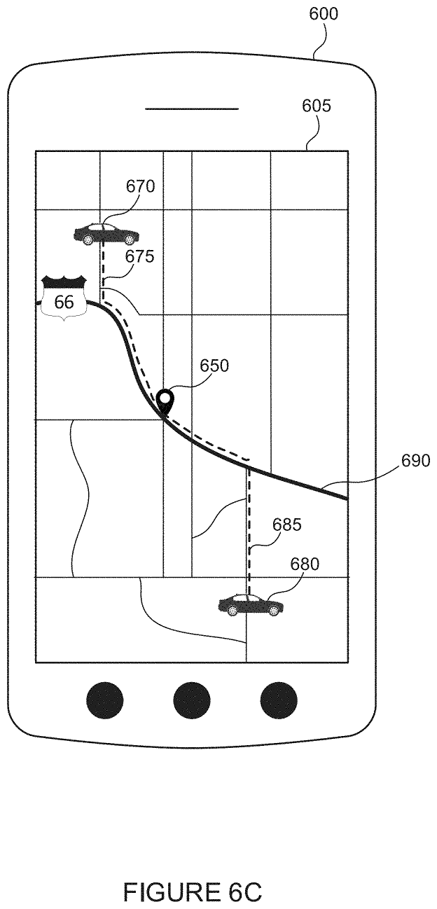

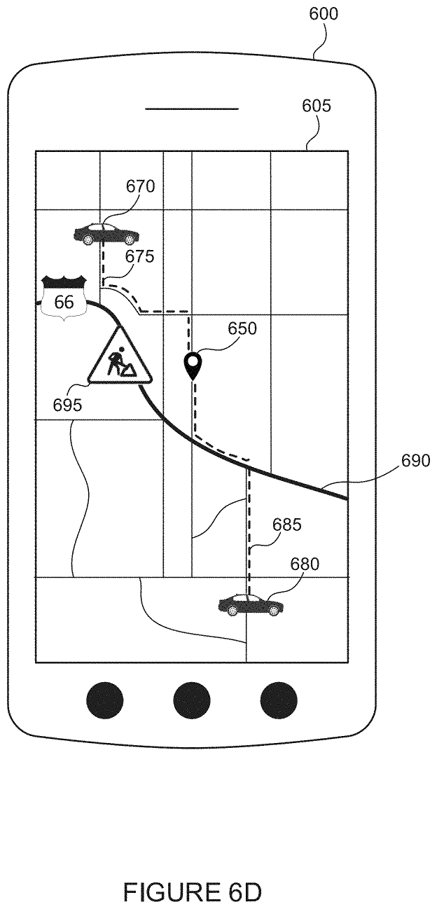

Once again, although much of this application discusses platooning vehicles, none of this should be construed as being limiting in any way, and in particular should not preclude applications that do not involve platooning vehicles. Discussion of embodiments that do not include platooning can be found throughout the present disclosure, and in particular with regard to FIGS. 6A-6D.

Thus, without limitation, the Applicant has proposed various vehicle platooning systems in which a second, and potentially additional, vehicle(s) is/are automatically, or semi-automatically controlled to closely follow a lead/front vehicle in a safe manner. By way of example, U.S. patent application Ser. Nos. 15/605,456, 15/607,902; 13/542,622 and 13/542,627; U.S. Provisional Patent Application Nos. 62/377,970 and 62/343,819; and PCT Patent Application Nos. PCT/US2014/030770, PCT/US2016/049143, PCT/US2018/41684, and PCT/US2016/060167 describe various vehicle platooning systems in which a trailing vehicle (also referred to herein as a rear vehicle) is at least partially automatically controlled to closely follow a designated lead vehicle. Each of these earlier applications are incorporated herein by reference.

One of the goals of platooning is typically to maintain a desired position between the platooning vehicles and/or a desired relative speed and/or time headway (e.g., a gap may refer to a distance, a headway, or both). Thus, it should be appreciated that, herein, any reference to the term “gap” could refer to a distance, a headway, or both. Further, while the term “maintain” is used throughout this disclosure, maintaining may mean staying within a gap (distance/headway), staying at a gap, and/or keeping at least a certain gap. Further, a desired gap may include a relative distance, time headway, and/or angle/offset. A longitudinal distance and/or time headway is frequently referred to herein as a “target gap”. That is, it is desirable for the trailing vehicle (e.g., a rear vehicle) to maintain a designated gap relative to a specific vehicle (e.g., a lead vehicle). The vehicles involved in a platoon will typically have sophisticated control systems suitable for initiating a platoon, maintaining the gap under a wide variety of different driving conditions, and gracefully dissolving (e.g., ending) the platoon as appropriate. It should be appreciated that herein, a gap may refer to a distance, a time headway, or either.

As described herein, the concept of platooning, also known as convoying, is still in its infancy. Academics have toyed with the concept over the last few decades, but to date there are no commercial systems on the road where a vehicle is at least partially controlled by another vehicle via a vehicle-to-vehicle connection (V2V). The benefits provided by such systems are obvious. Namely, the safety provided by these systems is far greater than a system where a rear vehicle doesn't begin to slow down until its radar or LIDAR sensors determine that a lead vehicle is slowing down. Further, by being able to follow another vehicle at a close distance, in some cases both a rear vehicle and a front vehicle may experience significant fuel savings.

As platoonable vehicles (e.g., vehicles capable of platooning) begin to roll out of the labs and into commercial production, their adoption faces significant challenges. For example, some people theorize that platooning may only work well when two platoonable vehicles depart a transportation hub at the same time and are traveling to the same location. However, for platooning to reach its full potential and provide greater savings (e.g., increase its efficiency), it would be desirable for systems to assist platoonable vehicles with meeting (e.g., rendezvousing) at locations other than where the respective vehicles start their trips. For instance, it would be desirable if a single platoonable vehicle traveling on a road could meet with another platoonable vehicle to start a platoon. With this capability, the likelihood that a fleet's vehicles will platoon may increase because, even when a fleet does not have two platoonable vehicles departing from the same location at the same time, the platoonable vehicles may be able to meet another platoonable vehicle on their route with which they may platoon (and thus increase the safety of the platooning vehicles and save fuel).

Herein, systems and methods for such a system are described. For example, systems (such as fleet management systems) that incorporate the ability for platoonable vehicles to meet up are described herein. It should be understood that systems described herein may recommend directions or other information to drivers (e.g., via a display), and/or they may cause vehicles to follow certain directions (e.g., via an at least partially automated driving system that controls a vehicle). Thus, regardless of whether systems described in the present disclosure are referring to providing recommendations/notifications to a driver, or referring to causing/controlling a vehicle to drive at least partially automatically, it should be understood that either may apply and the two may be used interchangeably.

Further, it should be understood that herein terms such as “rendezvous”, “meet”, “meetup”, and “meet-up” may be used interchangeably. In addition, the term “rendezvous location” may be used interchangeably with the term “rendezvous point”, and each may be referred to simply as a location where appropriate. It should be apparent to one of skill in the art whether a location is referring to a “rendezvous location”. Similarly, the term “rendezvous time” may be used, as well as the term “time”. It should be apparent to one of skill in the art whether a time is referring to a “rendezvous time”. Moreover, the term “time” may refer to an exact moment in time (e.g., 1:00 p.m.), a window of time (e.g., 1:00 p.m.-1:05 p.m.), etc.

In various embodiments, a system may include a user interface including a display within a vehicle. As will be described herein, this display—and possibly additional communication systems—may provide navigation maps and/or instructions to one or more vehicles such that two or more vehicles are able to rendezvous. Herein, rendezvous may be a verb or a noun, and refer to a meeting location and/or a time (e.g., a specific location or approximate location, and a specific time or approximate time/window of time for vehicles to converge). In various embodiments, rendezvous information may be provided that indicates that a rendezvous location is: (1) in traffic (e.g., the rendezvous occurs while two or more vehicles are moving/travelling), or (2) at a stationary location such as a rest stop, restaurant, gas station, etc. Additionally one or both vehicles may be stationary or may be moving. In cases where there is a driver for one or both vehicles, that driver may be in the vehicle, or could be outside the vehicle such as resting or waiting.

In various embodiments, a system including a GNSS (e.g., GPS) receiver may show a driver in at least one of the vehicles in near-real-time turn-by-turn directions to arrive at a rendezvous location. The system may also provide a driver with information about the location of other vehicles the driver plans to rendezvous with, and an estimated time that the vehicles will meet. Such a system allows drivers to know how far apart their platooning partner is from their current location, and how far they are from the rendezvous location so they can platoon together.

Put another way, in various embodiments two or more platoonable trucks want to platoon, but are at different locations. To save fuel and increase safety, they want to meet up with each other. When multiple trucks on the road want to get together, systems described herein may determine when and where the best place for the vehicles to meet is based on a variety of attributes including physical attributes associated with each truck, roadway attributes, weather, vehicle destinations, etc. From a driver's perspective, when such a system is activated they may see a navigation map which tells them where to go, what speed to travel at, where to stop, where a meetup location will be, what time the meetup will occur at, and/or what route to take to arrive at the meetup location.

As such, a system may calculate an optimal rendezvous location and time, and provide that information to a driver. In some embodiments one or more vehicles may be on city streets and a system may route them through city streets and onto a freeway where a platoonable vehicle is already traveling. This system may instruct one or more vehicles to get onto a freeway at a particular time such that the one or more vehicles are close to other platoonable vehicles already traveling on the freeway (e.g., a system may instruct a vehicle to wait before entering a freeway so they may easily meet up with other platoonable vehicles). Platoonable vehicles may be shown on a display while traveling on a freeway to help a driver know whether to speed up or slow down to platoon with a vehicle that just entered a freeway. In another embodiment, a system may instruct a vehicle already on a freeway to exit and meet with another vehicle to platoon with. In such a case, the vehicles may meet at a location such as a parking lot, a street where they may park, a rest stop, a restaurant, etc. and then get back onto a freeway and begin platooning.

In various embodiments, a rendezvous location may change. For example, two vehicles may be traveling to a first location and due to unforeseen traffic or other delays, it may not be as efficient for the vehicles to meet at the first location. In such an embodiment, a rendezvous location may be updated to create a more efficient rendezvous location and time for the two vehicles. Whether responding to a change in a rendezvous location and/or time, in various embodiments described herein one or more vehicles may need to travel faster, or travel slower, in order to meet at a rendezvous location/time. As such, a determination of a meeting point could be based on fuel consumption. For instance, if an amount of fuel saved by platooning on a given route is less than an amount of fuel spent by traveling faster to meet up with a platoonable vehicle, a system might advise a driver (or cause a vehicle) to not rendezvous with the other vehicle.

In some embodiments, one or more rendezvous locations may be more desirable than others, and a system may recommend that vehicles meet at those one or more locations. For example, a system may recommend that vehicles meet at a truck stop, a restaurant, or a rest stop rather than recommending they meet on a freeway while both vehicles are moving. In some embodiments, it is contemplated that all rendezvous locations may be located at a stationary location (e.g., rendezvousing at a rest stop as opposed to on a freeway while moving). In such embodiments, a system may determine a rendezvous location in its normal manner, and determine that the rendezvous location should be on a freeway while the vehicles are traveling. However, rather than making the rendezvous location be on the freeway, the system may place the rendezvous location at a stationary location (e.g., the nearest stationary location, a rest stop, a restaurant, the side of the road, and/or a location based on a user/driver's preferences which may be included in a user/driver's profile/social media account or historical information).

In some embodiments, if it is determined that when a threshold amount of efficiency may be gained (e.g., fuel savings, time) by rendezvousing on a freeway, then a recommendation to meet on a freeway may be made rather than meeting at a stationary location. The rendezvous location or time may also change based on the travel of a third vehicle, for example in cases where a passenger in one vehicle might need to transfer to a third vehicle, and that vehicle has been delayed.

In some embodiments, as mentioned above, two or more vehicles may rendezvous at a stationary location (as opposed to meeting while traveling on a road/freeway). Such a stationary place may be on the side of a road, a parking lot, a truck stop, a gas station, a restaurant, a loading dock, a trailhead, a railway stop, a location within a mine, etc. Systems may suggest or cause a vehicle to go to a location where there is a high chance of platooning. For example, a system may set a rendezvous point for a vehicle to be a rest stop where there are multiple platoonable vehicles which will be traveling on the same or similar routes that the vehicle may be traveling on. As such, the probability of rendezvousing with another vehicle to platoon with may increase since there are many platoonable vehicles with which to platoon.

In some embodiments, a rendezvous location may be determined by a system, wherein both vehicles must travel to the location. For example, a system may notify a first driver to travel to a rest stop which takes a first vehicle 7 minutes arrive at, and notify a second driver to travel to the rest stop which takes that second vehicle 4 minutes to arrive at. Sometimes, a system may recommend that a vehicle that is closer to that rest stop to travel slower so it may conserve fuel. In some embodiments, a system may collect information (e.g., at a Network Operations Center (NOC)) regarding how a driver behaves. For example, a system may collect, analyze, and process information about a driver's speed when given a location, whether a driver responds to recommendations provided by the system, etc., and then the system may make future decisions based on driver behavior.

Similarly, in some embodiments a system may recommend that two or more vehicles traveling on roadways enter a freeway and rendezvous while traveling on that freeway. For example, one vehicle may be in a downtown area and another may be at a loading dock. A system may determine that both vehicles will be traveling on the same route (e.g., from Dallas to San Antonio), and recommend that the vehicles travel to a freeway to rendezvous and platoon. In some embodiments, two or more vehicles may take different amounts of time to arrive at a rendezvous location on a freeway. For example, the vehicle downtown may take an hour to arrive at the rendezvous location, while the vehicle at the loading dock may take 10 minutes to arrive at the rendezvous location. In some embodiments, a system may recommend that the vehicle at the loading dock wait 50 minutes to travel to the rendezvous location, while recommending that the vehicle downtown begin traveling to the rendezvous location immediately. This way, both vehicles may reach the rendezvous location at the same time, at which point they may platoon with each other.

In some embodiments, it is further considered that a loading dock (or other location where trucks may wait (e.g., for their turn to load or unload freight)) may be connected to the system. In such a case, a system may recommend that a truck which has 50 minutes to wait before it begins to travel to a rendezvous location let another truck load/unload before it. For example, when one truck is waiting to load freight and has 50 minutes to wait before it should travel to a rendezvous location, the truck may allow another truck to load freight before it (e.g., skip the line), particularly if the other truck is in a hurry (e.g., if the other truck is causing other trucks to wait to platoon separately from the other two trucks—the one downtown and the one at the loading dock with 50 minutes to wait).

In some embodiments, a vehicle may rendezvous with another vehicle based on a location. For example, if a first vehicle is geofenced into traveling within a first area, and another vehicle is geofenced into traveling within a second area that overlaps (or comes close to overlapping) with the first area, a rendezvous location may be within the area that overlaps. For example, if a company that provides people rides doesn't let a first set vehicles travel past a particular road, and it lets a second set of vehicles travel only past the particular road, then a rendezvous location may be at or near that particular road. Of course, a rendezvous location may be based on other factors as well.

As mentioned above and as will be described in greater detail below with regard to FIGS. 6A-6D, in various embodiments methods and systems described herein may have nothing to do with vehicles or platooning. In various embodiments, systems and methods will be described wherein one or more electronic devices (e.g., a mobile phone, a navigation system) agree to rendezvous. As with other embodiments discussed herein, a rendezvous location may be determined/suggested based on the devices' current locations, traveling speed, destinations, and other attributes. Other attributes may include, but are not limited to: a current planned route (e.g., a predetermined/suggested route, which may be determined/suggested by a system such as the rendezvousing system, a fleet management system, a navigation system, etc.), route restrictions such as pickup and/or drop-off (e.g., of freight) locations, factors impacting a potential speed of travel on a route, road condition, construction (e.g., road construction, building construction), a gradient, a speed limit, timing restrictions such as pickup and/or drop-off (e.g., of freight) time constraints, driver hours of service, weather, points of interest (e.g., restaurants, residential buildings, office buildings), locations associated with a user (e.g., locations of places a user has interacted with on a social media platform), construction, an amount of fuel/energy remaining, whether an additional user/electronic device requests to rendezvous, an amount of time to arrive at a location on public transportation, and other unexpected circumstances such as a flat tire.

In various embodiments, a system and/or vehicles themselves may manipulate traffic to arrive at a destination (e.g., a rendezvous location) at a particular time. For example, if a first vehicle will take 20 minutes to reach a rendezvous location (e.g., a parking place near an onramp to a freeway), and a second vehicle will take 30 minutes to reach the rendezvous location, the system may control traffic lights to attempt to cause the second vehicle to reach the rendezvous location in less than 30 minutes. In some embodiments, only certain traffic lights may be manipulated. In that case, a system may recommend a vehicle take a route where a greater number of traffic lights may be manipulated, or at least an amount that would likely cause the vehicle to arrive at the rendezvous location sooner. Further, in some embodiments traffic lights may be manipulated if two or more vehicles are platooning such that both can make it through a traffic light they otherwise would not both make it through.

In some embodiments, a system may provide drivers/vehicles with a plurality of times at which they may rendezvous with one or more additional platoonable vehicles. For example, a schedule may indicate that vehicles are meeting a location at 6:00 a.m., 6:30 a.m., 7:00 a.m., 7:30 a.m., 8:00 a.m., 8:30 a.m., and 9:00 a.m. to travel on a particular route (e.g., Houston to El Paso). A system may recommend that a vehicle arrive at a rendezvous location at one of these times, such that it may rendezvous with other vehicles traveling on the same route. In some embodiments, if the platoon is traveling through another city, a system may indicate that vehicles in the other city (e.g., San Antonio—which is 3.5 hours away from Houston) may join the platoon at a rendezvous location on a freeway at 9:30 a.m., 10:00 a.m., 10:30 a.m., 11:00 a.m. 11:30 a.m., 12:00 a.m., and 12:30 a.m. In such an embodiment, vehicles may be able to leave when they choose so they may platoon on a particular road. This information may be provided via a mobile device, a display within a vehicle, an electronic log book, etc. In some embodiments, a system may be updated (e.g., at particular intervals) to provide a vehicle with the optimal time to arrive at a rendezvous location.

As mentioned above, it should be understood that in various embodiments a system may provide a recommendation to a driver within a truck, a recommendation to someone remote from the truck (e.g., a fleet manager) who can then relay that information to a driver of a truck, or the system may send directions (instead of or in addition to a recommendation) such that a vehicle with at least partial automation may travel to a rendezvous location with or without driver input. In some embodiments, in response to two vehicles beginning to platoon (e.g., after they meet at a rendezvous location), one or more vehicles may change their operation mode to be more automated. For example, one of the vehicles may enter a follow-the-leader mode, wherein a rear vehicle operates without driver input while the lead vehicle requires driver input. As another example, once two vehicles begin to platoon both may enter an automated state that does not require any driver intervention. It should be understood that embodiments described herein that discuss providing a recommendation to a driver to travel to a location at a particular time may be used interchangeably with embodiments where a system causes an at least partially automated vehicle to travel to a location at a particular time.

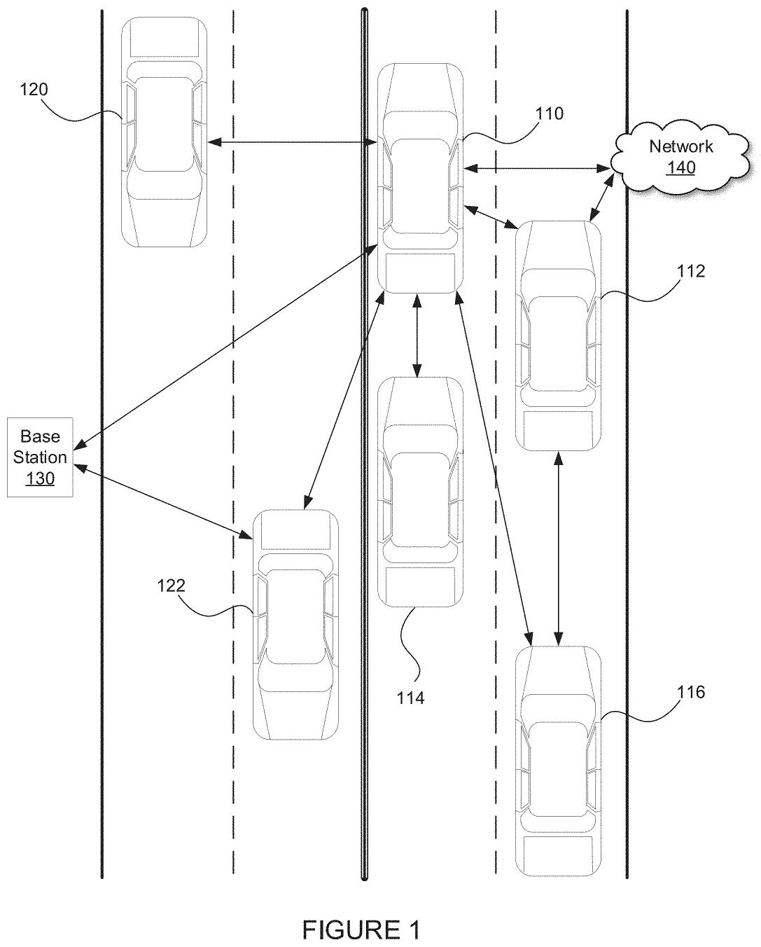

FIG. 1 illustrates a diagram of vehicles transmitting data, in accordance with some embodiments. FIG. 1. depicts multiple vehicles 110, 112, 114, 116, 120, and 122. FIG. 1 also depicts a base station 130 and a network 140. In various embodiments, vehicle 110 may transmit data (also referred to as information) to other vehicles 112, 114, 116, 120, and 122 directly, via base station 130, and/or via network 140. Vehicle 110 may also receive data from other vehicles 112, 114, 116, 120, and 122 directly, via base station 130, and/or via network 140. In some embodiments, a vehicle (e.g., vehicle 112) may retransmit information received from a first vehicle (e.g., vehicle 110) to another vehicle (e.g., vehicle 116) with or without additional information (e.g., information generated at vehicle 112 in addition to information received from vehicle 110).

In various embodiments, vehicles 110, 112, 114, 116, 120, and 122 may be configured to platoon, and may platoon with one another. In some embodiments, vehicles may transmit and/or receive data (e.g., to a NOC and/or fleet management system, etc.) including, but not limited to data indicating: whether they are available to platoon; whether they are platooning; whether a platoon they were part of dissolved; what direction they are traveling; what direction they are predicted (e.g., predetermined/planning on/suggested) to be traveling on for a particular period of time; when they are expected to stop (e.g., predetermined to stop, planning on stopping, suggested stopping time); where they plan on stopping; what route(s) they plan to travel (e.g., a route suggested and/or determined by a system, a route determined by a navigation/mapping system based on their destination such a system may be a rendezvousing system, a fleet management system, a navigation system, etc.); what type of platooning system they are equipped with; how many hours they have been on the road; weather they are capable of following the leader (e.g., if one or more vehicles can platoon without a driver); whether they are capable of being the leader in a follow-the-leader system; whether the vehicle is fully autonomous (e.g., capable of level 4 according to the SAE classification system); how much fuel they have saved; how much money they have saved; an area they are allowed to travel within; an area they are not allowed to travel outside of; whether they are capable of platooning on city streets; whether they are only capable of platooning on a highway; whether they are capable of platooning on non-public roads; whether they are capable of platooning in a particular construction site, mine, forest, etc.; and whether other attributes associated with a vehicle's account allows them to platoon. As should be understood, one or more of these attributes may be used to determine whether a vehicle can platoon with one or more additional vehicles, and whether a vehicle should platoon with one or more additional vehicles. It is contemplated that in some embodiments, a system may rank one or more vehicles with which a vehicle should platoon. In such an embodiment, if a target vehicle (e.g., a vehicle with a high ranking) that a first vehicle attempts to platoon with platoons with second vehicle before the first vehicle is able to platoon with the target vehicle, then the first vehicle may select another (e.g., the next) ranked vehicle that the system would like it to (e.g., determines that it should attempt to) platoon with.

In addition to these factors, other information that a vehicle may transmit and/or receive may include data including, but not limited to data associated with a/an: position, latitude, longitude, altitude, heading, speed, longitudinal and lateral acceleration, relative angle, type of load (e.g., type of materials a vehicle is carrying), brake status, brake pressure, path history, path projection, travel plans, vehicle size, vehicle type, brake type, current operating mode (autonomous or manual), map data, traffic information, GPS augmentation information (e.g., delays from infrastructure), wheel speed, wheel torque, gross torque, net torque, wind, rain, music, video, infotainment system, suspension, axle weight(s), transmission status (e.g., what gear the vehicle is in, what gear the vehicle was in, what gears the vehicle transferred from and to (e.g., fifth gear to fourth gear)), previous transmission status, hybrid vehicle drivetrain (e.g., a parallel hybrid or an electric hybrid), whether a vehicles with a vehicle with an electric mo, battery, electronic throttle control, throttle pedal, brake pedal, power steering, adaptive cruise control, a blowout, interior lighting, exterior lighting, retarder, anti-lock brakes, emergency braking, engine governor, powertrain, gear ratio, wheel size, wheel type, trailer length, trailer type, trailer height, amount of trailers, trailer position, current trailer position, past trailer position, tractor type, tractor height, transceiver type, current fuel, next determined stop, projected miles remaining until fuel tanks are empty, malfunctions, turn signals, LIDAR, radar, ultrasonic sensors, road surface, wheel angle, tire pressure, cabin temperature, engine temperature, trailer interior temperature, camera, fleet of vehicles, NOC, computer vision, other vehicle traveling in the same direction, other vehicle traveling in an opposite direction, and intervening traffic (e.g., cut-ins, also referred to as the situation when a vehicle enters an area between a lead vehicle and a rear vehicle). This information can be used by one or more vehicles, systems, fleets, etc. to determine whether a vehicle may platoon with another vehicle and/or to determine the best vehicle with which a vehicle may platoon. Again, it is contemplated that in some embodiments, a system may rank one or more vehicles with which a vehicle should platoon, and this ranking may be based on vehicle the vehicle attributes described above. In such an embodiment, if a target vehicle that a first vehicle wishes to platoon with platoons with another vehicle before the first vehicle is able to platoon with the target vehicle, then the first vehicle may move to another (e.g., the next) ranked vehicle that the system would like it to (e.g., determines that it should attempt to) platoon with.

It should be understood that, herein, when a system determines a rendezvous location and/or rendezvous time, that any of these attributes/information/data may be used alone or in combination to determine: whether two or more vehicles can platoon together, a rendezvous location, a rendezvous time, etc.

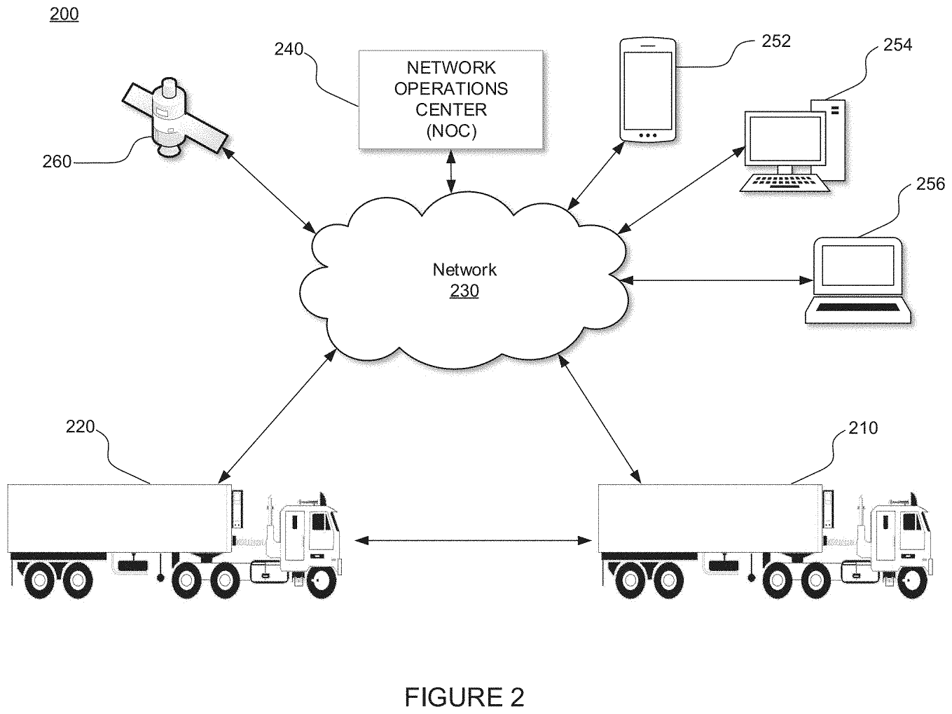

FIG. 2 illustrates an example system 200 including two vehicles capable of platooning and associated communication links. Vehicles 210 and 220 are depicted by trucks which are capable of platooning, and can communicate with each other directly or through network 230. Direct communication between two vehicles can occur wirelessly via Dedicated Short Range Communications (DSRC) (e.g., the IEEE 802.11p protocol), which is a two-way short to medium range wireless communications technology that has been developed for vehicle-to-vehicle (V2V) communications. Of course, other communications protocols and channels may be used in addition to or in place of a DSRC link. For example, the inter-vehicle communications may additionally or alternatively be transmitted over a cellular communications channel such as 4G LTE Direct, 5G, a Citizen's Band (CB) Radio channel, one or more General Mobile Radio Service (GMRS) bands, one or more Family Radio Service (FRS) bands, Wi-Fi, Zigbee and/or any other now existing or later developed communications channels using any suitable communication protocols either alone or in combination.

FIG. 2 also includes a network operations center (NOC) 240. NOC 240 may include one or more locations from which network monitoring, control, and/or management may be exercised over a communication network (e.g., a NOC may be located in the cloud/a multi-tenant environment). NOC 240 can oversee a complex network of vehicles, satellite communications, web applications, and/or management tools. Users of NOC 240 may be responsible for monitoring one or more networks, sub-networks, fleets of vehicles, and/or sub-fleets of vehicles that may require special attention to avoid degraded service. For example, NOC 240 may receive information about various vehicles 210 and 220 such as their locations and attributes, run various programs based on the received information, and send information back to vehicles 210 and 220, including indicating whether they are allowed to platoon.

In addition to NOC 240, client devices 252 (e.g., a smartphone or tablet), 254 (e.g., a desktop computer or terminal), and 256 (e.g., a laptop computer or terminal) may be used to send and/or receive information about vehicles 210 and 220, NOC 240, or information from canonical sources such as the Internet (e.g., Google Maps or another online map provider, a traffic provider, a weather provider, etc.). Client devices can be used to view attributes of vehicles 210 and 220 such as their location, an estimate of their weight, their speed, an amount of engine torque, amount of applied break, a destination, etc.

FIG. 2 also includes a satellite 260, which can send signals to network 230, NOC 240, and/or vehicles 210 and 220. Satellite 260 may be part of a satellite navigation system such as a global navigation satellite system (GNSS). GNSSs include the United States's Global Positioning System (GPS), Russia's GLONASS, China's BeiDou Navigation Satellite System, and the European Union's Galileo. Based on information sent from satellite 260, systems described herein can determine locations of vehicles 210 and 220.

Of course, it should be appreciated that the system described in FIG. 2 is only an example, and that many other configurations may exist. For example, a NOC may assist with the monitoring and control of hundreds or thousands of vehicles, and many types of web applications may exist.

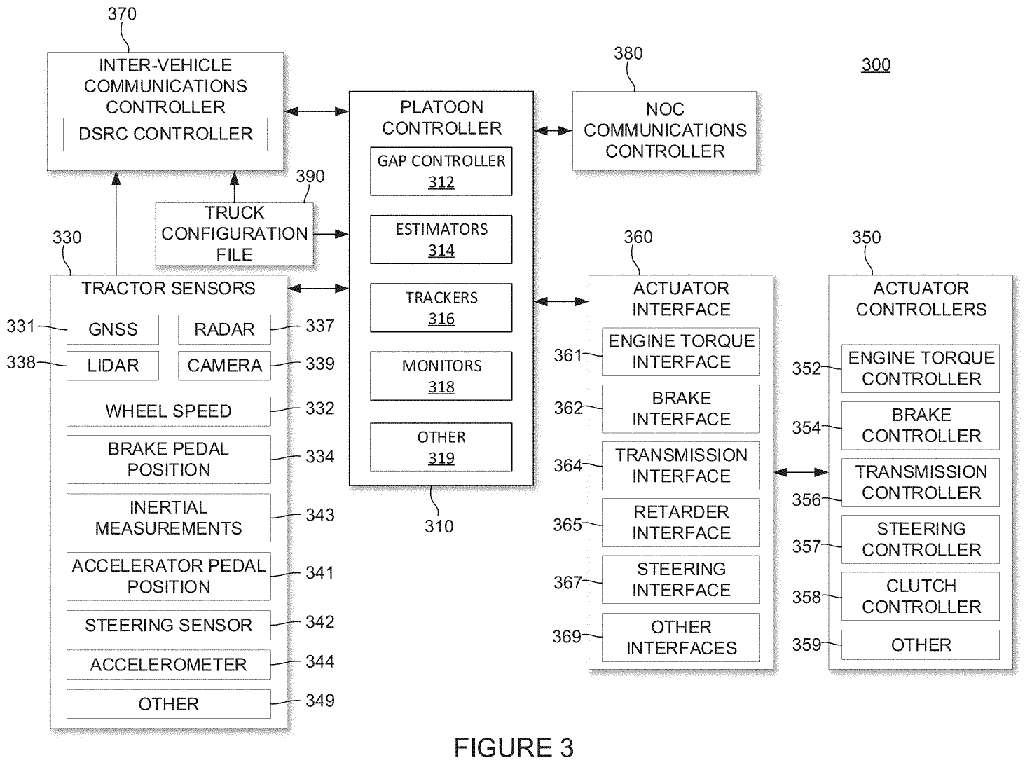

FIG. 3 illustrates and example system 300 including a platoon controller 310 (also referred to as a platoon electronic control unit, a platoon ECU, or a PECU). As described throughout this disclosure, a wide variety of configurations may be used to implement platooning systems described herein. The specific controller design can vary based on the level of automation contemplated for the controller, as well as the nature of and equipment available on the host vehicles participating in the platoon. FIG. 3 illustrates components of one possible configuration.

FIG. 3 diagrammatically illustrates a vehicle control architecture that can be suitable for use with platooning tractor-trailer trucks. The specific controller, or platooning ECU, illustrated is primarily designed for use in conjunction with a platooning system in which both vehicles include an active driver. The driver of the lead vehicle being fully responsible for control of the lead vehicle. In some embodiments the driver of the rear vehicle may be responsible for steering the rear vehicle, but the platoon controller 310 is primarily responsible for controlling the rear vehicle's torque and braking requests during active platooning. However, as discussed herein, it should be appreciated that generally similar control schemes can be used in systems which contemplate more automated control of one or both of the platoon partners or which utilize vehicle control commands other than or in addition to torque and braking requests.

In the example embodiment illustrated in system 300, a platoon controller 310, receives inputs from a number of sensors 330 on the tractor and/or one or more trailers or other connected units, and a number of actuator controllers 350 (also referred to as electronic control units or ECUs) arranged to control operation of the tractor's powertrain and other vehicle systems. An actuator interface 360 may be provided to facilitate communications between the platoon controller 310 and the actuator controllers 350. In some embodiments, one or more of the actuator interfaces 360 may be included in one or more of the actuator controllers 350 (e.g., an actuator interface may be included in an ECU). Platoon controller 310 also interacts with an inter-vehicle communications controller 370 (also referred to as an inter-vehicle communications ECU) which orchestrates communications with the platoon partner and a NOC communications controller 380 (also referred to as a NOC communication ECU) that orchestrates communications with a NOC. The vehicle also may have selected configuration files 390 that include known information about the vehicle.

Some of the functional components of the platoon controller 310 include gap controller 312, a variety of estimators 314, one or more partner vehicle trackers 316 and various monitors 318. In many applications, the platoon controller 310 will include a variety of other components 319 as well.

Some of the sensors utilized by platoon controller 310 may include GNSS unit 331, wheel speed sensors 332, inertial measurement devices 334, radar unit 337, lidar unit 338, cameras 339, accelerator pedal position sensor 341, steering wheel position sensor 342, brake pedal position sensor 343, and various accelerometers 344. Of course, not all of these sensors will be available on all vehicles involved in a platoon and not all of these sensors are required in any particular embodiment. A variety of other sensors 349 (now existing or later developed or commercially deployed) may be additionally or alternatively be utilized by platoon controller 310 in other embodiments.

Many (but not all) of the described sensors, including wheel speed sensors 332, radar unit 337, accelerator pedal position sensor 341, steering wheel position sensor 342, brake pedal position sensor 343, and accelerometer 344 are relatively standard equipment on newer trucks (tractors) used to pull semi-trailers. However, others, such as GNSS unit 331 and lidar unit 338 (if used) are not currently standard equipment on such tractors or may not be present on a particular vehicle and may be installed as needed or desired to help support platooning.

FIG. 3 also illustrates various actuator controllers 350. It should be understood that, in various embodiments, some or all types of controllers may be referred to interchangeably as electronic control units (ECUs). It should, however, be understood that some ECUs may control actuators, some ECUs may control communications, some ECUs may monitor sensors, and some may perform any combination thereof. Thus, it should be appreciated that the system shown in FIG. 3 is merely one of a wide variety of systems that may be used to control platooning.

Some of the vehicle actuator controllers 350 that platoon controller 310 may direct at least in part include engine torque controller 352; brake controller 354; transmission controller 356; steering/automated steering controller 357; and clutch controller 358. Of course, not all of these actuator controllers will be available or are required in any particular embodiment and it may be desirable to interface with a variety of other vehicle actuator controllers 359 that may be available on the vehicle as well. Therefore, it should be appreciated that the specific actuator controllers 350 directed or otherwise utilized by the platoon controller on any particular controlled vehicle may vary widely. Further, the capabilities of any particular actuator controller (e.g. engine torque controller 352), as well as its interface (e.g., the nature and format of the commands, instructions, requests and messages it can handle or generate) will often vary with the make and model of that particular actuator controller. Therefore, an actuator interface 360 is preferably provided to translate requests, commands, messages and instructions from the platoon controller 310 into formats that are appropriate for the specific actuator controller hardware and software utilized on the controlled vehicle. The actuator interface 360 also provides a mechanism for communicating/translating messages, commands, instructions and requests received from the various actuator controllers back to the platoon controller 310. In some embodiments, an appropriate actuator interface may be provided to interact with each of the specific vehicle controllers utilized. In various embodiments, this may include one or more of: an engine torque interface 361; a brake interface 362; a transmission interface 364; a retarder interface 365; a steering interface 367; and/or any other appropriate controller interface 369. In some embodiments, various controllers may be combined (e.g., in the case of a chasses controller, or an engine ECU that also controls a retarder—which may obviate the need for a retarder ECU).

Large trucks and other heavy vehicles frequently have multiple systems for “braking” the truck. These include the traditional brake system assemblies mounted in the wheels of the vehicle—which are often referred to in the industry as the “foundation brakes.” Most large trucks/heavy vehicles also have a mechanism referred to as a “retarder” that is used to augment the foundation brakes and serve as an alternative mechanism for slowing the vehicle or to help prevent the vehicle from accelerating down a hill. Often, the retarder may be controlled by the engine torque controller 352 and in such embodiments, the retarder can be controlled by sending appropriate torque commands (which may be negative) to engine torque controller 352. In other embodiments a separate retarder controller (not shown) may be accessible to, and therefore directed by, platoon controller 310 through an appropriate retarder interface 365. In still other embodiments, the platoon controller 310 may separately determine a retarder command that it sends to the actuator interface 360. In such embodiments the actuator interface will interpret the retard command and pass on appropriate retardation control commands to an Engine ECU or other appropriate vehicle controller.

The communications between vehicles may be directed over any suitable channel and may be coordinated by inter-vehicle communications controller 370. As described above, the DSRC protocol may work well.

The specific information transmitted back and forth between the vehicles may vary widely based on the needs of the controllers. In various embodiments, the transmitted information may include the current commands generated by the platoon controller 310 such as requested/commanded engine torque, and/or requested/commanded braking deceleration 382. They may also include steering commands, gear commands, etc. when those aspects are controlled by platoon controller 310. Corresponding information is received from the partner vehicle, regardless of whether those commands are generated by a platoon controller or other suitable controller on the partner vehicle (e.g., an adaptive cruise control system (ACC) or a collision mitigation system (CMS)), or through other or more traditional mechanisms—as for example, in response to driver inputs (e.g., accelerator pedal position, brake position, steering wheel position, etc.).

In many embodiments, much or all of the tractor sensor information provided to platoon controller 310 is also transmitted to the platoon partner and corresponding information is received from the platoon partner so the platoon controllers 310 on each vehicle can develop an accurate model of what the partner vehicle is doing. The same is true for any other relevant information that is provided to platoon controller 310, including any vehicle configuration information 390 that is relevant to platoon controller 310. It should be appreciated that the specific information transmitted may vary widely based on the requirements of platoon controllers 310, the sensors and actuators available on the respective vehicles, and the specific knowledge that each vehicle may have about itself.

The information transmitted between vehicles may also include information/data about intended future actions as will be discussed in greater detail below. For example, if the lead vehicle knows it is approaching a hill, it may expect to increase its torque request (or decrease its torque request in the context of a downhill) in the near future and that information can be conveyed to a rear vehicle for use as appropriate by the platoon controller 310. Of course, there is a wide variety of other information that can be used to foresee future torque or braking requests and that information can be conveyed in a variety of different forms. In some embodiments, the nature of the expected events themselves can be indicated (e.g., a hill, curve, or exit is approaching) together with the expected timing of such events. In other embodiments, the intended future actions can be reported in the context of expected control commands such as the expected torques and/or other control parameters and the timing at which such changes are expected. Of course, there are a wide variety of different types of expected events that may be relevant to the platoon control.

The communications between the vehicles and the NOC may be transmitted over a variety of different networks, such as a cellular network, various Wi-Fi networks, DSRC networks, satellite communications networks and/or any of a variety of other networks as appropriate. The communications with the NOC may be coordinated by NOC communications controller 380. The information transmitted to and/or received from the NOC may vary widely based on the overall system design. In some circumstances, the NOC may provide specific control parameters such as a target gap. These control parameters or constraints may be based on factors known at the NOC such as speed limits, the nature of the road/terrain (e.g., hilly vs. flat, winding vs. straight, etc.) weather conditions, traffic or road conditions, etc. In other circumstances the NOC may provide information such information to platoon controller 310. The NOC may also provide information about the partner vehicle including its configuration information and any known relevant information about its current operational state such as weight, trailer length, etc.

Lastly, with regard to FIG. 3, configuration file 390 may include a wide variety of information about the host vehicle that may be considered relevant to controller 310. By way of example, some of the information might include the vehicle's specification including such things as engine performance characteristics, available sensors, the existence and/or type of platooning indicators (e.g., lights that indicate a vehicle is platooning), the nature of its braking system, the location of its GNSS antenna relative to the front of the cab, gear ratios, differential ratios etc. In some embodiments, configuration file 390 may include information about a driver, a fleet, a fleet's schedule, a driver rating, a driver's ability to use the system, whether a vehicle has permission to use a system, whether a vehicle is certified to use the system, etc.

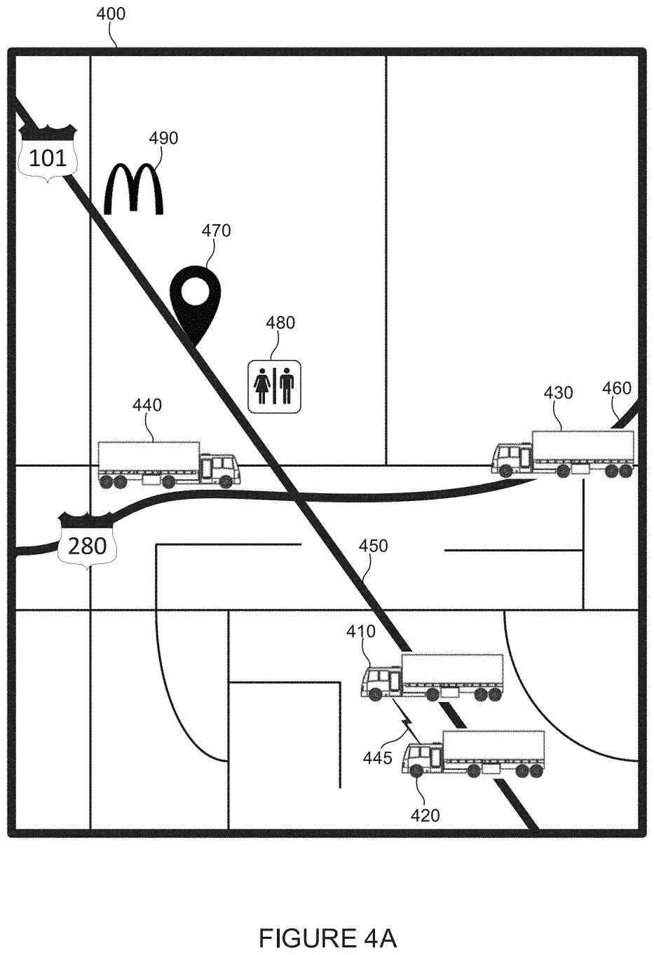

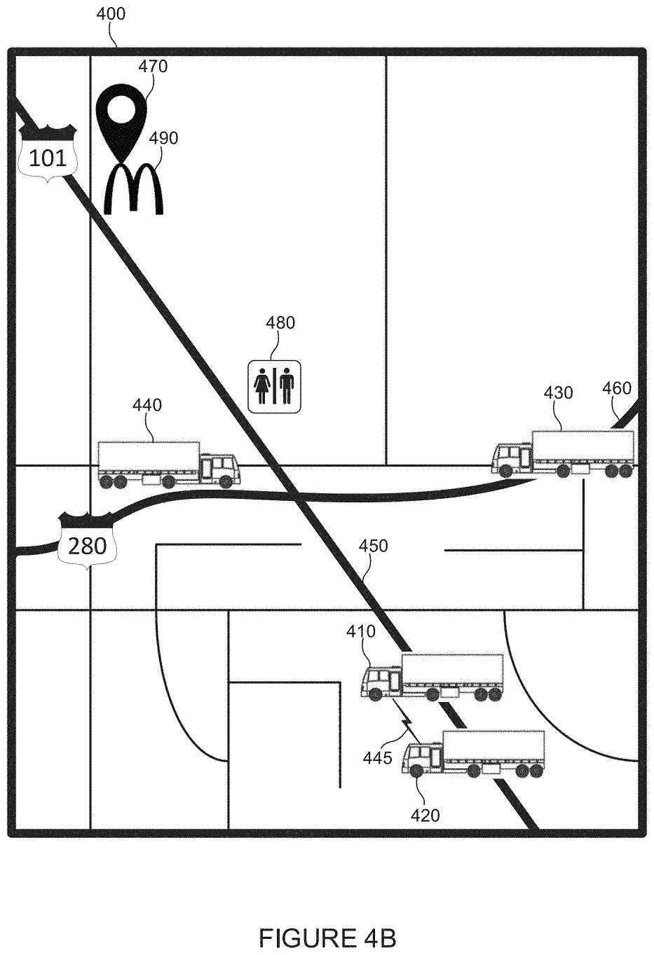

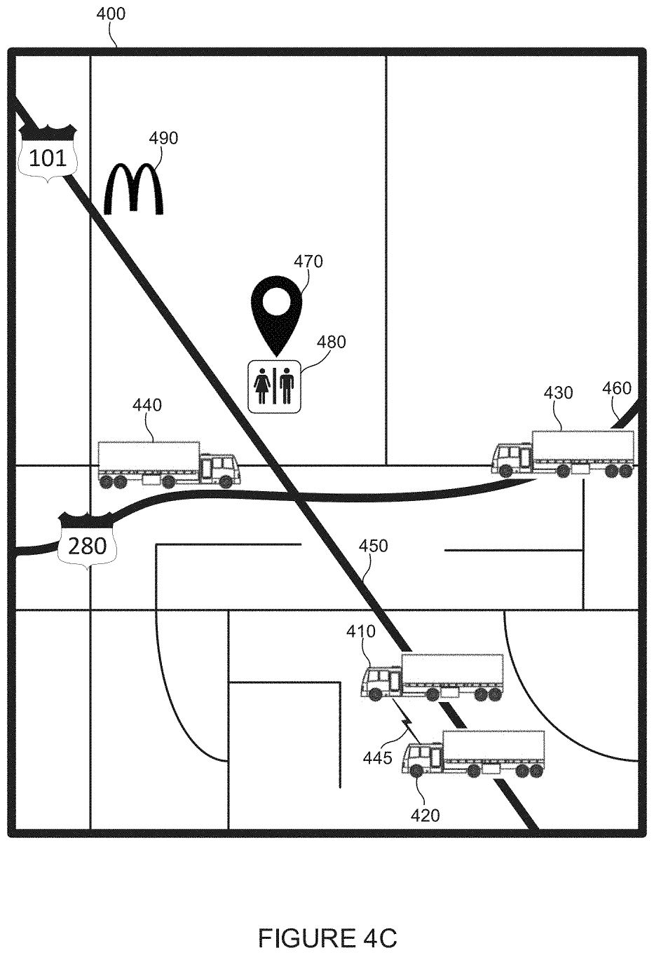

FIG. 4A illustrates an example map 400 including vehicles on roads, in accordance with some embodiments. Map 400 includes example vehicles 410, 420, 430, and 440. In some embodiments, vehicles 410 and 420 may be platooning and have a wireless communication link 445 between them. FIG. 4A also includes freeway 101 450, and freeway 280 460. In addition, FIG. 4A includes a rendezvous location 470, a rest stop 480, and a restaurant 490.

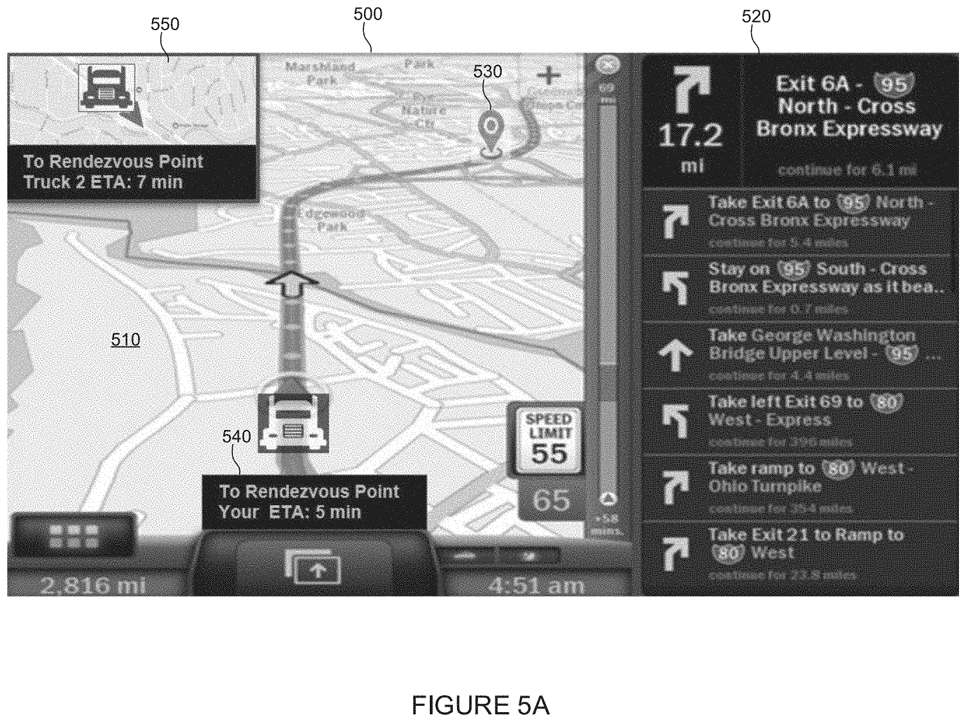

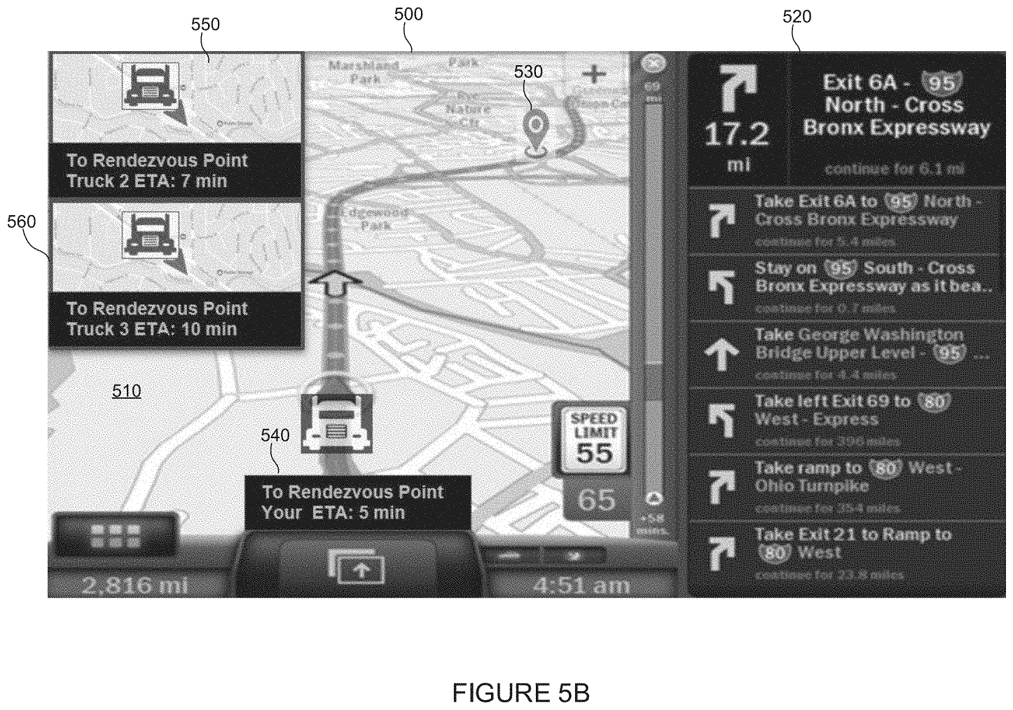

In some embodiments, a system including a NOC 240 may transmit and/or receive information from vehicles 410 and 420 indicating that they are platooning. NOC 240 may receive a request indicating that vehicles 430 and/or 440 wish to platoon on freeway 101 450 going northbound. In such a case, a system may provide vehicles 410, 420, 430, and/or 440 with information indicating where a rendezvous location 470 and time may be. Such information may be provided to a driver using a platooning system's graphical user interface (GUI), and/or another communication means. This information may be presented in a map (e.g., a navigation map as shown in FIGS. 5A and 5B) to a driver and/or to a remote terminal (e.g., where a fleet manager is controlling/monitoring vehicles). In one example, once two or more vehicles have determined that they will rendezvous they may be able to communicate with each other: over a private voice channel (as opposed to an open channel on a CB radio), via cellular communications, via the Internet, via video, etc. As discussed above, if one or more of the vehicles 410, 420, 430, and/or 440 are at least partially automated, information about the rendezvous location and/or time may not be displayed on a GUI within a vehicle.

In some embodiments, vehicle 440 may receive a recommendation that it wait to enter freeway 101 450 heading northbound for a few minutes to allow for vehicles 410, 420, and 430 to travel closer to rendezvous location 470. For instance, vehicle 440 may be directed to stop before it enters freeway 101 540, or at rest stop 480. Next, vehicles 410, 420, and/or 430 may meet vehicle 540 as it enters freeway 101 450 or they may stop at rest stop 480 to meet vehicle 440. To determine where the vehicles should rendezvous, calculations may be performed to optimize the efficiency of one or more of the vehicles. Such efficiency may include time, fuel savings, whether vehicles are in the same fleet, etc.

FIG. 4B illustrates example map 400 including vehicles on roads, in accordance with some embodiments. Map 400 includes example vehicles 410, 420, 430, and 440. In some embodiments, vehicles 410 and 420 may be platooning and have a wireless communication link 445 between them. FIG. 4B also includes freeway 101 450, and freeway 280 460. In addition, FIG. 4B includes a rendezvous location 470, a rest stop 480, and a restaurant 490.

FIG. 4B illustrates an example where rendezvous location 470 has moved from its location in FIG. 4A. As discussed herein, in some embodiments a rendezvous location may be static (e.g., it does not change until the vehicles arrive or the rendezvous is otherwise cancelled). In some embodiments, a rendezvous location may change (e.g., be dynamic) due to various circumstances (e.g., unforeseen circumstances at the time when the rendezvous location was determined). For example, one or more drivers (e.g., vehicles 410 and 420) may provide information to a system indicating that they are not stopping until they reach restaurant 490. In response, rendezvous location may be change from its location in FIG. 4A to its location in FIG. 4B (at restaurant 470). In another example, one or more drivers (e.g., vehicles 410 and 420) may provide information to a system indicating that construction occurred and that a rendezvous location closer to them may work better. As another example, weather may cause a vehicle to travel slower than expected, causing a rendezvous location to change.

FIG. 4C illustrates example map 400 including vehicles on roads, in accordance with some embodiments. Map 400 includes example vehicles 410, 420, 430, and 440. In some embodiments, vehicles 410 and 420 may be platooning and have a wireless communication link 445 between them. FIG. 4C also includes freeway 101 450, and freeway 280 460. In addition, FIG. 4C includes a rendezvous location 470, a rest stop 480, and a restaurant 490.

In some embodiments, a vehicle may arrive at a rendezvous location before other vehicles and wait for them. For example, vehicle 440 may arrive at rest stop 480 and wait for vehicles 410, 420, and/or 430. In such an example, rendezvous location 470 may be located at rest stop 480. Such a stop may allow for the vehicles 410, 420, 430, and/or 440 to travel a route they would otherwise already be traveling if vehicles 410, 420, 430, and/or 440 were planning on traveling northbound on freeway 101 450. It should be understood by one of skill in the art that the term “a route that a vehicle is planning on traveling” (or “a route that a vehicle plans on traveling”) may refer to a route that is determined, predetermined, and/or suggested by a rendezvous system, fleet management system, navigation system, electronic logging device or other suitable system.

FIG. 5A illustrates an example user interface 500, in accordance with some embodiments. In various embodiments user interface 500 may include a map 510, directions 520, rendezvous location 430, an estimated time of arrival 540 at rendezvous location 430, and information about another vehicle 550. In various embodiments the other vehicle 550 may be a vehicle with which a rendezvous has been scheduled, or it may be a vehicle with which a rendezvous is yet to be scheduled. In some embodiments, the information about the other vehicle 550 may include a map, the other vehicle's 550 estimated time of arrival at rendezvous point 530, etc. Other information may be included, such as the route vehicle 550 plans to travel (e.g., is expected to travel based on a determination by a system such as a rendezvous system, fleet management system, electronic logging system/device, and/or navigation system), a type of cargo vehicle 550 is carrying, a weight of vehicle 550, information about a driver of vehicle 550 (e.g., name, sex, rating, drivers license/identification number), a destination of vehicle 550, a maximum speed of vehicle 550, a fleet of which vehicle 550 is included in, etc. It should be understood that such information may also be available to a NOC, and not only displayed on user interface 500.

FIG. 5B illustrates and example user interface 500, in accordance with some embodiments. In various embodiments user interface 500 may include a map 510, directions 520, rendezvous location 430, an estimated time of arrival 540 at rendezvous location 430, and information about a second vehicle 550, and information about a third vehicle 560. (The first vehicle is the vehicle that contains user interface 500). User interface 500 in FIG. 5B is similar to user interface 500 in FIG. 5A, except user interface 500 in FIG. 5B illustrates an example wherein more than two vehicles are meeting at a rendezvous location 530.

In various embodiments, user interface 500 may include buttons/controls to provide a system with information associated with where a driver of the first vehicle would like to rendezvous, whether they are facing traffic they didn't expect, or anything that would otherwise cause the location of rendezvous location 530 to change.

FIG. 6A illustrates an example electronic device 600 including a display 605, in accordance with some embodiments. FIG. 6A includes a map with various roads (1st Avenue 610, 2nd Avenue 612, 3rd Avenue 614, A Street 616, B Street 618, and C Street 620). FIG. 6A also includes two pedestrians 630 and 640, who are traveling on routes 635 and 645 to rendezvous location 650.

In various embodiments, pedestrians 630 and 640 (e.g., humans on foot, but in some cases may also include humans on bicycles, scooters, skateboards, etc.) may connect with one another via an application on their electronic device (e.g., smartphone, navigation system) that determines rendezvous location 650. In some embodiments, such an application may include a social network, a texting application, a mapping/navigation application, a dedicated rendezvousing application (e.g., an application that does nothing other than assist with determining a rendezvous location as described in embodiments included herein), a scheduling system (e.g., for transporting freight), a dispatch system (e.g., for notifying drivers/vehicles of locations to be, view driver availability, etc., such as Axon Trucking Software, JFleet, Tailwind TMS Software).

In example FIG. 6A, pedestrians 630 and 640 may have used their electronic devices to attempt to determine a rendezvous location. While in some embodiments this location may be a coffee shop, restaurant, or other point of interest, in the example shown in FIG. 6A rendezvous location 650 is on B Street 618—about halfway between pedestrians 630 and 640—and thus the application recommends they travel on routes 635 and 645 to meet.

FIG. 6B also illustrates example electronic device 600, display 605, and roads 610, 612, 614, 616, 618, and 620. In this example, however, two police cars 660 and 665 have blocked B Street 618. In such an example (continuing from the example illustrated in FIG. 6A), routes 635 and 645 are updated/changed such that rendezvous location 650 is still roughly halfway between pedestrians 630 and 640, but routes 635 and 645 no longer requires pedestrian 630 to travel on B Street which is now blocked.

It should be appreciated that rendezvous location 150 may be recalculated/updated/changed one or more times, including a nearly continuous calculation/recalculation of rendezvous location 150. In other words, rendezvous location 150 may be recalculated in real- or near-real-time. In some embodiments, due to the frequency of recalculating rendezvous location 150, rendezvous location 150 may appear to be constantly moving on a map. For example, if rendezvous location 150 is inaccessible, restricted, and/or unavailable, a system may recalculate rendezvous location 150. In some embodiments, a vehicle operator and/or other user may send information to a system notifying the system that rendezvous location 150 is inaccessible, restricted, and/or unavailable (for instance, so a system will not recommend that particular location again). In some embodiments, when a system determines a rendezvous location it may receive information from a third-party source indicating whether a location is inaccessible, restricted, and/or unavailable. In another example, a vehicle may overshoot, or otherwise travel to a location where rendezvous location 150 would no longer be optimal for the two or more vehicles to rendezvous at. In such an embodiment, rendezvous location 150 may be recalculated and/or, in some cases, determine a new rendezvous location where a different rendezvous party (e.g., more or fewer vehicles that were not included within the original rendezvous location 150 determination), may be scheduled to rendezvous at (also referred to as pair/pairing). In some embodiments, a vehicle operator and/or other user of a system may notify the system that it is lost, experiencing traffic (e.g., due to construction), and/or otherwise would like rendezvous location 150 to be changed.

Further, it should be understood that the example systems and methods described with reference to FIGS. 6A and 6B may apply to forms of transportation in addition to walking. For example, the same basic systems and methods may employ vehicles (e.g., cars, horses, bicycles, scooters, trains, light-rail, construction equipment, trucks, at least partially-automated vehicles).

FIG. 6C illustrates an example electronic device 600 including a display 605, in accordance with some embodiments. FIG. 6C includes a map with freeway 66 690. FIG. 6C also includes two vehicles 670 and 680, which are traveling on routes 675 and 685 to rendezvous location 650. Similar to FIG. 6A, vehicles 670 and 680 may attempt to rendezvous with each other using electronic device 600 (e.g., a smartphone, a navigation device) to determine rendezvous location 650.

In some embodiments, rendezvous location 650 may be roughly halfway between vehicles 670 and 680 timewise. That is to say, although rendezvous location 650 may not be halfway between vehicles 670 and 680 distance-wise, rendezvous location 650 may take vehicles 670 and 680 the same or approximately the same amount of time to reach rendezvous location 650 from their current locations. Of course, traffic lights, weather, or other obstructions may change rendezvous location 650 such that it is still takes each vehicle 670 and 680 the same or approximately the same amount of time to reach rendezvous location 650.

In some embodiments, a rendezvous system may include settings that are adjustable by a user that cause the system to set rendezvous location 650 to be on a regular street, or on a freeway. In some embodiments systems described herein may allow a user to set their own preferences as to whether they would prefer rendezvous locations on roads, freeways, gas stations, rest stops, restaurants, coffee shops, etc. In some embodiments, a setting may cause a rendezvous location to never be on a freeway (e.g., while a vehicle is moving/travelling), always be at a rest stop, restaurant, gas station, transportation hub, or any combination thereof.

FIG. 6D also illustrates an example electronic device 600 including a display 605 which includes a map with freeway 66 690. FIG. 6D also includes vehicles 670 and 680, which are still traveling on routes 675 and 685 to rendezvous location 650 (as in FIG. D).

Similar to FIGS. 6A and 6B, an obstruction 695 may cause rendezvous location 650 to change such that vehicles 670 and 680 may still meet at rendezvous location 650 (e.g., at about the same time). In some embodiments, rendezvous location 650 may be closer distance-wise to one vehicle (e.g., vehicle 670) because another vehicle (e.g., vehicle 680) is able to travel on a freeway and arrive at rendezvous location 650 in the same amount of time, even though the vehicle (e.g., vehicle 680) has a longer distance to travel.

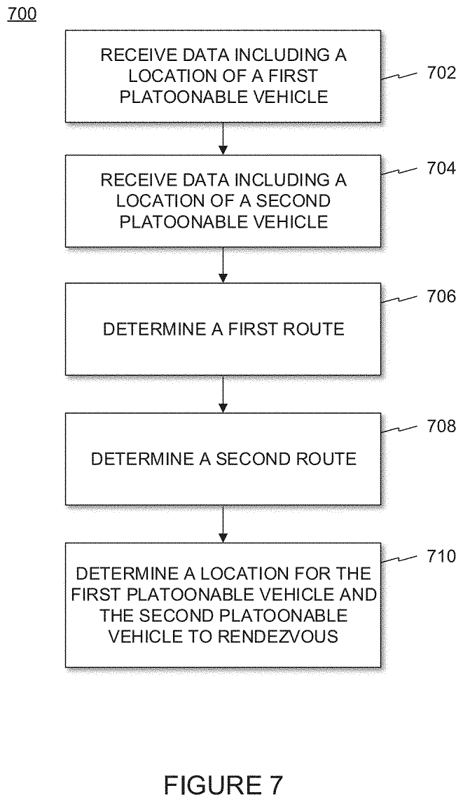

FIG. 7 shows a flowchart 700 of a method for determining a time for a platoonable vehicle to travel on one or more roads, in accordance with various embodiments. While the various steps in the flowchart is presented and described sequentially, one of ordinary skill will appreciate that some or all of the steps can be executed in different orders and some or all of the steps can be executed in parallel. Further, in one or more embodiments of the invention, one or more of the steps can be omitted, repeated, and/or performed in a different order. Accordingly, the specific arrangement of steps shown in FIG. 7 should not be construed as limiting the scope of the invention. In one or more embodiments, the steps of FIG. 7 can be performed by example systems 100, 200, 300, and/or computing system 800.

In step 702, data is received including the location of a first platoonable vehicle. This data may be received by a fleet manager, a NOC, or another system. The rendezvous location may be based on the location of this first platoonable vehicle, and/or attributes associated with the first platoonable vehicle such as what fleet it is in, what type of cargo it is carrying, etc.

In step 704, data is received including the location of a second platoonable vehicle. This data may be received by a fleet manager, a NOC, or another system. As with the first platoonable vehicle, the rendezvous location may be based on the location of this second platoonable vehicle, and/or attributes associated with the second platoonable vehicle such as what fleet it is in, what type of cargo it is carrying, etc.

In some embodiments herein, vehicles may only platoon with other vehicles from the same fleet and/or vehicles made by the same original equipment manufacturer (OEM). In some embodiments, vehicles may platoon with any other vehicles (e.g., from a different fleet, vehicles made by a different OEM).

In step 706, a first route is determined. The first route may be a route that the first platoonable vehicle is expected to travel based on a determination/predetermination/suggestion by a system such as a rendezvous system, fleet management system, electronic logging system/device, and/or navigation system (e.g., a route that the first platoonable vehicle plans to travel). This route may be received by a fleet manager, a NOC, or another system. A route may be stored in a vehicle, in an electronic log, in the cloud, etc. The route may be based on a current location of a vehicle and a planned destination of a vehicle, while considering variations such as traffic, construction, weather, an amount of weigh stations, an amount of traffic lights, etc. A time to arrive at a certain place (e.g., a destination, rendezvous location) may be estimated using at least the same factors. In some embodiments, a route/time to arrive at a certain place may be based on information received from other vehicles (e.g., the speed of a vehicle on a particular road, the time it takes a vehicle to travel from one location to another).

In step 708, a second route is determined. The second route may be a route that the first platoonable vehicle is expected to travel based on a determination/predetermination/suggestion by a system such as a rendezvous system, fleet management system, electronic logging system/device, and/or navigation system (e.g., a route that the second platoonable vehicle plans to travel). This route may be received by a fleet manager, a NOC, or another system. This route may be determined in similar ways as described above. For example, the route may be based on which road would be the shortest between a current location and a destination, traffic as determined by other vehicles' sensors/GPS receivers, traffic/speed as determined by a mobile device such as a smartphone, traffic/speed as determined by information entered into an electronic device such as a smartphone or other terminal by a user, etc.

In step 710, a location (e.g., the rendezvous location) for the first platoonable vehicle and the second platoonable vehicle to rendezvous is determined. In some embodiments, the rendezvous location may be based at least in part on one or more of a variety of attributes, including, but not limited to: the location of the first platoonable vehicle, the location of the second platoonable vehicle, the route the first platoonable vehicle plans to travel, and the route the second platoonable vehicle plans to travel, a distance between the first platoonable vehicle and the second platoonable vehicle, a predicted travel time of one or more vehicles to reach the rendezvous location, weather, traffic, whether a vehicle becomes incapacitated (e.g., breaks down), whether additional trucks desire/attempt/are commanded to join the (potential) platoon, a current planned route, route restrictions such as pickup and/or drop-off (e.g., of freight) locations, factors impacting a potential speed of travel on a route such as a speed limit, timing restrictions such as pickup and/or drop-off (e.g., of freight) time constraints, driver hours of service, construction, and an amount of fuel/energy remaining.

In some embodiments, the rendezvous location may be based at least in part on attributes of one or more vehicles (and/or drivers) including, but not limited to a/an: position, latitude, longitude, altitude, heading, speed, longitudinal and lateral acceleration, relative angle, type of load (e.g., type of materials a vehicle is carrying), brake status, brake pressure, path history, path projection, travel plans, vehicle size, vehicle type, brake type, current operating mode (autonomous or manual), driver experience, a driver's certifications, map data, traffic information, GPS augmentation information (e.g., delays from infrastructure), wheel speed, wheel torque, gross torque, net torque, wind, rain, music, video, infotainment system, suspension, axle weight(s), transmission status, battery, electronic throttle control, throttle pedal, brake pedal, power steering, adaptive cruise control, a blowout, interior lighting, exterior lighting, retarder, anti-lock brakes, emergency braking, engine governor, powertrain, gear ratio, wheel size, wheel type, trailer length, trailer type, trailer height, amount of trailers, trailer position, current trailer position, past trailer position, tractor type, tractor height, transceiver type, current fuel, next planned stop, projected miles remaining until fuel tanks are empty, malfunctions, turn signals, LIDAR, radar, ultrasonic sensors, tire pressure, cabin temperature, engine temperature, trailer interior temperature, camera, etc.

In some embodiments, a rendezvous location may be updated/changed. For example, a rendezvous location may be located at an area 7 miles ahead on a road for a first vehicle, and 5 miles ahead on a road for a second vehicle. If something unexpected were to happen causing the vehicles to not to make it to the rendezvous location at an estimated time, the rendezvous location may be updated such that it is 3 miles farther up the road than the previous rendezvous location.

In some embodiments, various calculations may be performed to determine a rendezvous location. For example, but not limited to:
By determining a set of routes for each vehicle that are compatible with a set of locations they must each travel to, including any time windows for each location.
Predicting the timing of each vehicle for each route, based on known factors such as traffic.
Calculating a weighted proximity for each combination of routes for the two vehicles, based on chosen weighting factors including:
   The nearest physical location of one or more vehicles on their respective routes;
   The total travel time of one or more vehicles; and
   A predicted amount of fuel usage for the one or more vehicles.
Performing the above operations at least a second time
   Determining a set of routes for each vehicle that are compatible with a set of locations they must each travel to, including any time windows for each location.
   Predicting the timing of each vehicle for each route, based on known factors such as traffic.
   Calculating a weighted proximity for each combination of routes for the two vehicles, based on chosen weighting factors
Any of the combination of routes that minimized the weighted function above.
Identifying the rendezvous location as the location along one or more routes (e.g., a predetermined route) where the one or more vehicles are closest together.

In various embodiments, the calculations performed above may determine a route and/or rendezvous location and can be presented to a driver. In some embodiments, a driver may select a route and/or send a notification to other drivers and/or systems indicating which route was selected (and, in some cases, whether that route was the suggested route). A system may present a driver (and/or other system/vehicle operator) with a plurality of suggested routes, allowing for more flexibility by providing multiple routes to choose from.

Embodiments described herein may be discussed in the general context of computer-executable instructions residing on some form of computer-readable storage medium, such as program modules, executed by one or more computers or other devices. By way of example, and not limitation, computer-readable storage media may comprise non-transitory computer-readable storage media and communication media; non-transitory computer-readable media include all computer-readable media except for a transitory, propagating signal. Generally, program modules include routines, programs, objects, components, data structures, etc., that perform particular tasks or implement particular abstract data types. The functionality of the program modules may be combined or distributed as desired in various embodiments.

This disclosure contains numerous references to a NOC and to one or more processors. According to various aspects, each of these items may include various kinds of memory, including non-volatile memory, to store one or more programs containing instructions for performing various aspects disclosed herein.

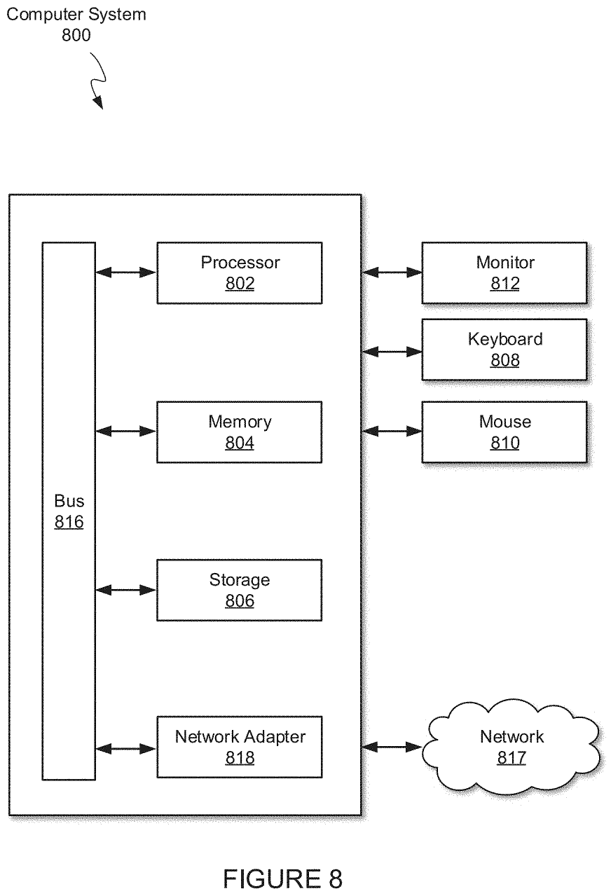

For example, as shown in FIG. 8, example computing system 800 may include one or more computer processor(s) 802, associated memory 804 (e.g., random access memory (RAM), cache memory, flash memory, read only memory (ROM), electrically erasable programmable ROM (EEPROM), or any other medium that can be used to store the desired information and that can be accessed to retrieve that information, etc.), one or more storage device(s) 806 (e.g., a hard disk, a magnetic storage medium, an optical drive such as a compact disk (CD) drive or digital versatile disk (DVD) drive, a flash memory stick, etc.), and numerous other elements and functionalities. The computer processor(s) 802 may be an integrated circuit for processing instructions. For example, the computer processor(s) may be one or more cores or micro-cores of a processor. The computing system 800 may also include one or more input device(s) 810, such as a touchscreen, keyboard, mouse, microphone, touchpad, electronic pen, or any other type of input device. Further, the computing system 800 may include one or more output device(s) 808, such as a screen (e.g., a liquid crystal display (LCD), a plasma display, touchscreen, cathode ray tube (CRT) monitor, projector, or other display device), a printer, external storage, or any other output device. The computing system 800 may be connected to a network 814 (e.g., a local area network (LAN), a wide area network (WAN) such as the Internet, mobile network, or any other type of network) via a network interface connection 818. The input and output device(s) may be locally or remotely connected (e.g., via the network 812) to the computer processor(s) 802, memory 804, and storage device(s) 806.

One or more elements of the aforementioned computing system 800 may be located at a remote location and connected to the other elements over a network 814. Further, embodiments of the invention may be implemented on a distributed system having a plurality of nodes, where each portion of the invention may be located on a subset of nodes within the distributed system. In one embodiment of the invention, the node corresponds to a distinct computing device. Alternatively, the node may correspond to a computer processor with associated physical memory. The node may alternatively correspond to a computer processor or micro-core of a computer processor with shared memory and/or resources.\

For example, one or more of the software modules disclosed herein may be implemented in a cloud computing environment. Cloud computing environments may provide various services and applications via the Internet (e.g., the NOC). These cloud-based services (e.g., software as a service, platform as a service, infrastructure as a service, etc.) may be accessible through a Web browser or other remote interface.

Communication media can embody computer-executable instructions, data structures, and program modules, and includes any information delivery media. By way of example, and not limitation, communication media includes wired media such as a wired network or direct-wired connection, and wireless media such as acoustic, radio frequency (RF), infrared, and other wireless media. Combinations of any of the above can also be included within the scope of computer-readable media.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered as examples because many other architectures can be implemented to achieve the same functionality.

The embodiments disclosed herein may also be implemented using software modules that perform certain tasks. These software modules may include script, batch, or other executable files that may be stored on a computer-readable storage medium or in a computing system. These software modules may configure a computing system to perform one or more of the example embodiments disclosed herein. One or more of the software modules disclosed herein may be implemented in a cloud computing environment.

While this disclosure has been described in terms of several aspects, there are alterations, modifications, permutations, and equivalents which fall within the scope of this disclosure. In view of the many alternative ways of implementing the methods and apparatuses of the present disclosure, it is intended that the following appended claims be interpreted to include all such alterations, modifications, permutations, and substitute equivalents as falling within the true scope of the present disclosure.

1. A method for determining a location for a first platoonable vehicle and a second platoonable vehicle to rendezvous, comprising:
receiving data including a location of the first platoonable vehicle, wherein the term platoonable includes an ability of a vehicle to control another vehicle via wireless signals;
receiving data including a location of the second platoonable vehicle;
determining a first route, wherein the first route is a suggested route for the first platoonable vehicle to travel;
determining a second route, wherein the second route is a suggested route for the second platoonable vehicle to travel; and
determining the location for the first platoonable vehicle and the second platoonable vehicle to rendezvous, wherein the location is based at least in part on the location of the first platoonable vehicle, the location of the second platoonable vehicle, the first route, and the second route, and wherein the first platoonable vehicle is a first truck, and wherein the second platoonable vehicle is a second truck; and
causing the first platoonable vehicle and the second platoonable vehicle to platoon after they have rendezvoused.

2. The method of claim 1, further comprising:
causing the first platoonable vehicle and the second platoonable vehicle to rendezvous.

3. The method of claim 1, wherein receiving data including the location of the first platoonable vehicle, receiving data including the location of the second platoonable vehicle, determining the first route, determining the second route, and determining the location for the first platoonable vehicle and the second platoonable vehicle to rendezvous occurs at a network operations center (NOC).

4. The method of claim 1, wherein determining the location for the first platoonable vehicle and the second platoonable vehicle to rendezvous is further based on the group comprising: a speed of at least one of the first platoonable vehicle and a second platoonable vehicle, a current route of the first platoonable vehicle and the second platoonable vehicle, route restrictions, an amount of traffic, a speed limit, drop-off timing restrictions, pickup timing restrictions, and driver hours of service constraints.

5. The method of claim 1, wherein the location for the first platoonable vehicle and the second platoonable vehicle to rendezvous is updated prior to the first platoonable vehicle and the second platoonable vehicle rendezvousing.

6. The method of claim 5, wherein the location for the first platoonable vehicle and the second platoonable vehicle to rendezvous changes due to unforeseen circumstances at the time the location for the first platoonable vehicle and the second platoonable vehicle to rendezvous was determined.

7. (canceled)

8. The method of claim 1, further comprising:
determining a time for the first platoonable vehicle and the second platoonable vehicle to rendezvous.

9. The method of claim 1, further comprising:
providing the location for the first platoonable vehicle and the second platoonable vehicle to rendezvous to the first platoonable vehicle and the second platoonable vehicle.

10. The method of claim 1, wherein receiving the first location of the first platoonable vehicle, receiving the second location of the second platoonable vehicle, and determining the location for the first platoonable vehicle and the second platoonable vehicle to rendezvous occurs at a network operations center (NOC).

11. The method of claim 1, wherein the location for the first platoonable vehicle and the second platoonable vehicle to rendezvous is static.

12. The method of claim 1, wherein the location for the first platoonable vehicle and the second platoonable vehicle to rendezvous changes prior to the first platoonable vehicle and the second platoonable vehicle platooning.

13. The method of claim 1, wherein the determination of the location for the first platoonable vehicle and the second platoonable vehicle to rendezvous is based at least in part on a distance between the first platoonable vehicle and the second platoonable vehicle.

14. The method of claim 1, wherein the first platoonable vehicle commands torque of the second platoonable vehicle.

15. The method of claim 1, wherein the determination of the location for the first platoonable vehicle and the second platoonable vehicle to rendezvous is based at least in part on a predetermined route of the first platoonable vehicle and a predetermined route of the second platoonable vehicle.

16. The method of claim 1, wherein the determination of the location for the first platoonable vehicle and the second platoonable vehicle to rendezvous is based at least in part on an estimated speed of the first platoonable vehicle when traveling to the location and an estimated speed of the second platoonable vehicle when traveling to the location.

17. The method of claim 1, wherein the determination of the location for the first platoonable vehicle and the second platoonable vehicle to rendezvous is based at least in part on the closest possible location that the first platoonable vehicle and the second platoonable vehicle can reach when traveling at a predicted speed to the location for the first platoonable vehicle and the second platoonable vehicle to rendezvous.

18. The method of claim 1, wherein the first platoonable vehicle must wait at the location for the first platoonable vehicle and the second platoonable vehicle to rendezvous until the second platoonable vehicle arrives.

19. A system for determining a rendezvous location, wherein the system comprises:
a processor;
a memory; and
a rendezvousing engine, wherein the rendezvousing engine is configured to:
receive data including a location of the first platoonable vehicle, wherein the term platoonable includes an ability of a vehicle to control another vehicle via wireless signals;
receive data including a location of the second platoonable vehicle;
determine a first route, wherein the first route is a suggested route for the first platoonable vehicle to travel;
determine a second route, wherein the second route is a suggested route for the second platoonable vehicle to travel; and
determine the location for the first platoonable vehicle and the second platoonable vehicle to rendezvous, wherein the location is based at least in part on the location of the first platoonable vehicle, the location of the second platoonable vehicle, the first route, and the second route, and wherein the first platoonable vehicle is a first truck, and wherein the second platoonable vehicle is a second truck; and
causing the first platoonable vehicle and the second platoonable vehicle to platoon after they have rendezvoused.

20. The system of claim 19, wherein the rendezvousing engine is further configured to:
cause the first platoonable vehicle to operate without driver input in response to the first platoonable vehicle and the second platoonable vehicle platooning.

21-30. (canceled)

31. A non-transitory computer-readable storage medium comprising a plurality of instructions for determining a rendezvous location, the instructions configured to execute on at least one computer processor to enable the computer processor to:
receive data including a location of the first platoonable vehicle, wherein the term platoonable includes an ability of a vehicle to control another vehicle via wireless signals;
receive data including a location of the second platoonable vehicle;
determine a first route, wherein the first route is a suggested route for the first platoonable vehicle to travel;
determine a second route, wherein the second route is a suggested route for the second platoonable vehicle to travel; and
determine the location for the first platoonable vehicle and the second platoonable vehicle to rendezvous, wherein the location is based at least in part on the location of the first platoonable vehicle, the location of the second platoonable vehicle, the first route, and the second route; and
causing the first platoonable vehicle and the second platoonable vehicle platoon after they have rendezvoused.

32. The non-transitory computer-readable storage medium of claim 31, wherein the first platoonable vehicle is a first truck, and wherein the second platoonable vehicle is a second truck, and wherein the first platoonable vehicle and the second platoonable vehicle platoon after they have rendezvoused.

33. The non-transitory computer-readable storage medium of claim 31, wherein receiving data including the location of the first platoonable vehicle, receiving data including the location of the second platoonable vehicle, determining the first route, determining the second route, and determining the location for the first platoonable vehicle and the second platoonable vehicle to rendezvous occurs at a network operations center (NOC).

34. The non-transitory computer-readable storage medium of claim 31, wherein determining the location for the first platoonable vehicle and the second platoonable vehicle to rendezvous is further based on the group comprising: a speed of at least one of the first platoonable vehicle and a second platoonable vehicle, a current route of the first platoonable vehicle and the second platoonable vehicle, route restrictions, an amount of traffic, a speed limit, drop-off timing restrictions, pickup timing restrictions, and driver hours of service constraints.

35. The non-transitory computer-readable storage medium of claim 31, wherein the location for the first platoonable vehicle and the second platoonable vehicle to rendezvous is updated prior to the first platoonable vehicle and the second platoonable vehicle rendezvousing.

36. The non-transitory computer-readable storage medium of claim 31, wherein the location for the first platoonable vehicle and the second platoonable vehicle to rendezvous changes due to unforeseen circumstances at the time the location for the first platoonable vehicle and the second platoonable vehicle to rendezvous was determined.

37. The non-transitory computer-readable storage medium of claim 31, wherein the determination of the location for the first platoonable vehicle and the second platoonable vehicle to rendezvous is based at least in part on the closest possible location that the first platoonable vehicle and the second platoonable vehicle can reach when traveling at a predicted speed to the location for the first platoonable vehicle and the second platoonable vehicle to rendezvous.

38. The non-transitory computer-readable storage medium of claim 31, wherein the first platoonable vehicle must wait at the location for the first platoonable vehicle and the second platoonable vehicle to rendezvous until the second platoonable vehicle arrives.

39. The non-transitory computer-readable storage medium of claim 31, wherein the location for the first platoonable vehicle and the second platoonable vehicle to rendezvous changes prior to the first platoonable vehicle and the second platoonable vehicle rendezvousing.

40. The non-transitory computer-readable storage medium of claim 31, wherein the determination of the location for the first platoonable vehicle and the second platoonable vehicle to rendezvous is based at least in part on a predetermined route of the first platoonable vehicle and a predetermined route of the second platoonable vehicle.

41. The non-transitory computer-readable storage medium of claim 31, wherein the first platoonable vehicle or the second platoonable vehicle can operate without driver input.

42. The non-transitory computer-readable storage medium of claim 31, wherein the second platoonable vehicle can operate without driver input in response to platooning.
